(19) United States
(12) Patent Application Publication
(10) Pub. No.: US 2007/0240533 A1
(43) Pub. Date: Oct. 18, 2007

(54) Speed change operating structure for hydrostatic stepless speed-changing apparatus of work vehicle

(75) Inventors: Koji Masumoto, Osaka (JP); Kenzo Ushiro, Osaka (JP)

Correspondence Address: THE WEBB LAW FIRM, P.C., 700 KOPPERS BUILDING, 436 SEVENTH AVENUE, PITTSBURGH, PA, 15219, US

(73) Assignee: Kubota Corporation, Osaka-shi (JP)

(21) Appl. No.: 11/708,696

(22) Filed: Feb. 20, 2007

(30) Foreign Application Priority Data
Apr. 12, 2006 (JP) 2006-109929

(51) Int. Cl. G05G 11/00

(52) U.S. Cl. 74/481

(57) ABSTRACT

A speed change operating structure for a hydrostatic continuously variable speed-change apparatus of a work vehicle includes:

a speed change pedal for effecting a speed-changing operation of the hydrostatic continuously variable speed-change apparatus, the speed change pedal being urged in a direction toward its neutral position;

a speed-maintaining lever disposed adjacent a lateral side of a driver's seat included in the work vehicle;

a retaining member displaceable by an operation of the speed-maintaining lever in an operational direction and in an opposite direction to the operational direction; and

a restraining member movable in a first direction and a second direction opposite to the first direction, in association with an operation of the speed change pedal, the restraining member being engageable with the retaining member at a plurality of positions, an engagement between the restraining member and the retaining member preventing movement of the speed change pedal in the direction toward the neutral position thereof.

### BACKGROUND OF THE INVENTION

The present invention relates to a speed change operating structure for a work vehicle including a speed change pedal for effecting a speed-changing operation of a hydrostatic continuously variable speed-change apparatus (HST), and a speed-maintaining means for maintaining the speed change pedal at a desired forward speed-changing position.

According to a known example of the speed-maintaining means described above, a speed-changing lever operatively coupled with the speed change pedal is disposed adjacent a lateral side of a driver's seat. When this speed-changing lever is operated to a forward speed-changing range, a speed-changing operation of the hydrostatic continuously variable speed-change apparatus is effected via the speed change pedal and also the speed-changing lever is retained in position by a friction mechanism, so that the speed change pedal is retained at a desired forward traveling speed-changing position (see e.g. JP 2001-82597).

The friction type speed-maintaining means employed in the above-described speed change operating structure has an advantage of being capable of maintaining the speed change pedal in a forward traveling speed-changing range in a stepless manner. However, as the friction mechanism needs to provide a strong retaining force to overcome the neutral returning force, the construction would employ a multi-disc type frictional mechanism, so that the construction tends to have a great number of parts, hence, tending to be complicated. Especially, with this speed-maintaining means, it is required that when the brake pedal is stepped on under a speed-maintained condition to brake traveling of the vehicle, the speed-maintained condition be released to allow the hydrostatic continuously variable speed-change apparatus to return to its neutral position Hence, in order to provide the multi-disc type friction construction with such friction releasing function, the construction tends to be even more complicated.

### SUMMARY OF THE INVENTION

The present invention has been made in view of the above-described state of the art. The primary object of the invention is to solve at least some of the above problems of the conventional construction.

For accomplishing the above-noted object, according to the present invention, there is proposed a speed change operating structure for a hydrostatic continuously variable speed-change apparatus of a work vehicle, the operating structure comprising:

a speed change pedal for effecting a speed-changing operation of the hydrostatic continuously variable speed-change apparatus, the speed change pedal being urged in a direction toward its neutral position;

a speed-maintaining lever disposed adjacent a lateral side of a driver's seat included in the work vehicle;

a retaining member displaceable by an operation of the speed-maintaining lever in an operational direction and in an opposite direction to the operational direction; and

a restraining member movable in a first direction and a second direction opposite to the first direction, in association with an operation of the speed change pedal, the restraining member being engageable with the retaining member at a plurality of positions, an engagement between the restraining member and the retaining member preventing movement of the speed change pedal in the direction toward the neutral position thereof

### BRIEF DESCRIPTION OF THE DRAWINGS

FIG. 1 is a general side view of a tractor,

FIG. 2 is a general plan view of the tractor,

FIG. 3 is a side view of a speed change operating structure,

FIG. 4 is a side view showing the speed change operating structure under a neutral condition thereof,

FIG. 5 is a side view showing the speed change operating structure under a speed-maintaining condition thereof,

FIG. 6 is a side view of a speed-maintaining construction,

FIG. 7 is a plan view of the speed-maintaining construction, and

FIG. 8 is a side view showing the speed change operating structure under a condition thereof when the speed-maintaining condition has been forcibly released in association with a braking operation.

### DETAILED DESCRIPTION OF PREFERRED EMBODIMENTS

Next, preferred embodiments of the present invention will be described with reference to the accompanying drawings.

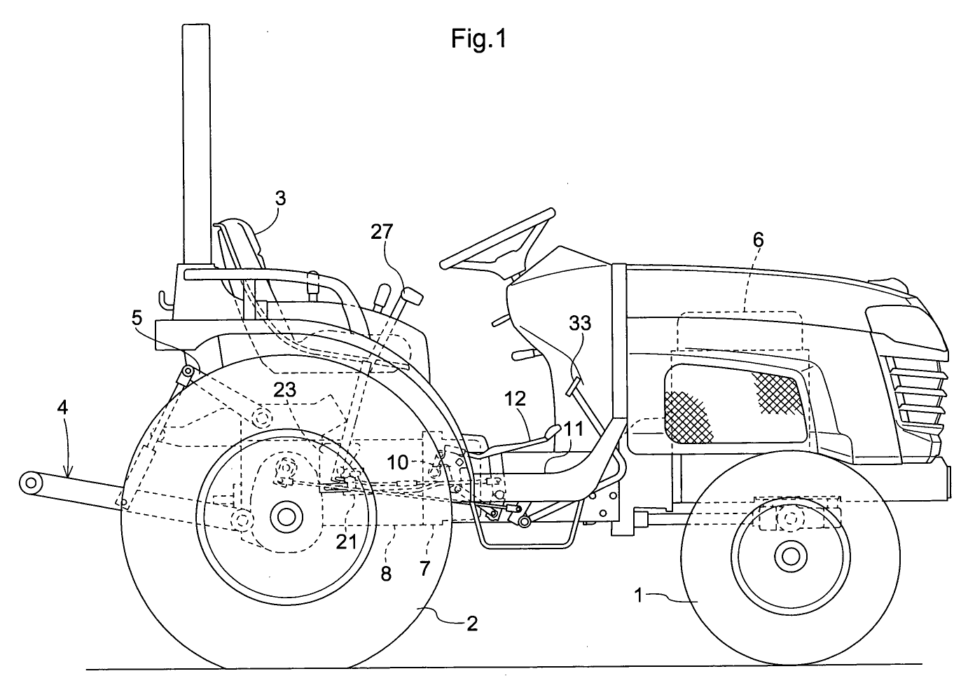

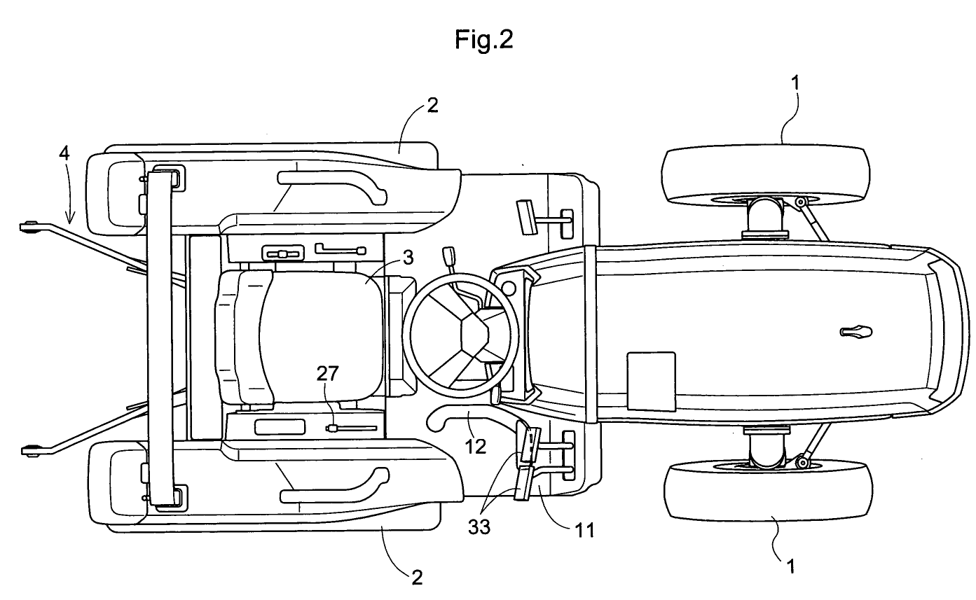

FIG. 1 shows a tractor mainly for agricultural uses, as an example of a work vehicle. This tractor is a four-wheel drive type including steerable front wheels 1 and main propelling rear wheels 2. At rear portions of the vehicle body, there are mounted a driver's seat 3, a three-point link mechanism 4 for coupling implements, lift arms 5 for hydraulically lifting up/down the link mechanism 4, etc. An engine 6 is mounted on a front portion of the vehicle body.

Power from the engine 6 is subjected to a stepless speed-changing operation in a forward direction (forward traveling direction) or a reverse direction (reverse traveling direction) by a hydrostatic continuously variable speed-change apparatus (HST) 7 and then inputted to a transmission case 8. In the transmission case 8, the inputted power is subjected to a gear speed-changing operation and the resultant gear speed-changed power is transmitted to the rear wheels 2 as well as to the front wheels 2 in distribution.

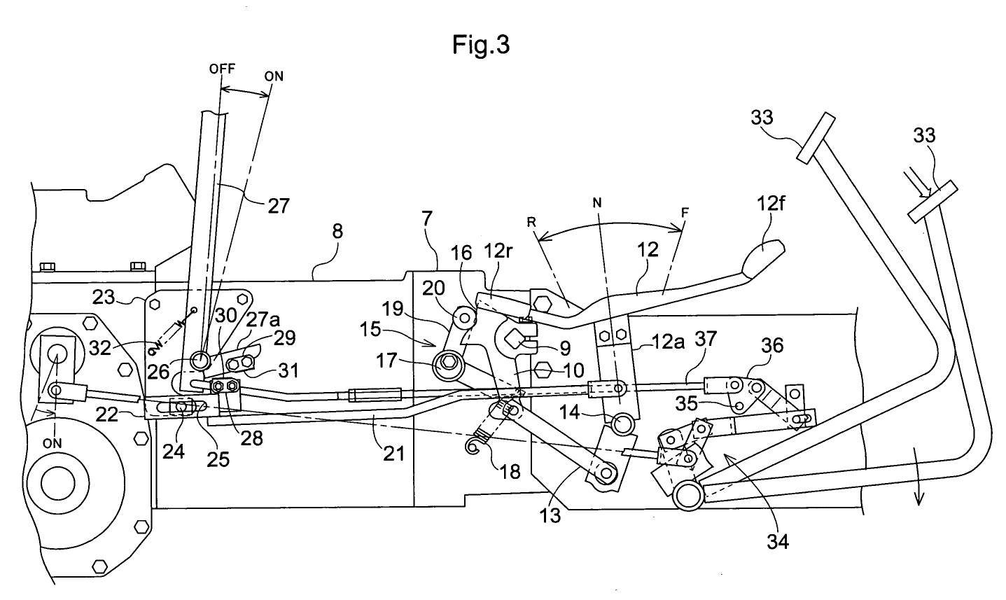

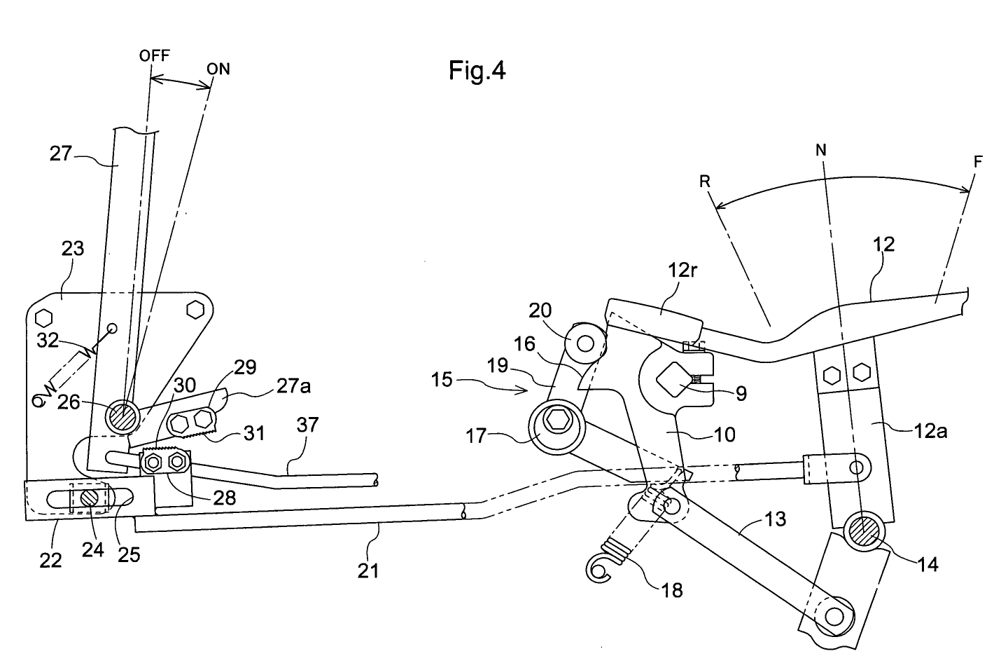

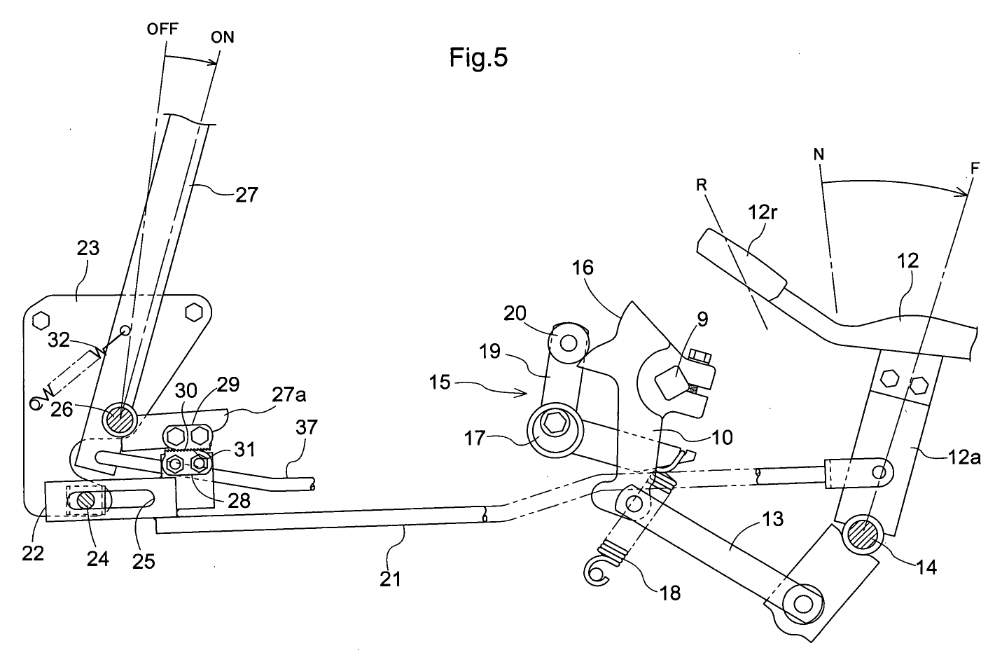

As shown in FIG. 3, from a right side face of the HST 7, there is projected a speed-changing operational shaft (trunnion shaft ) 9 for changing forwardly or reversely a swash plate angle of an unillustrated variable displacement pump incorporated within the HST 7. A speed-changing operational arm 10 is connected to a projecting end of this speed-changing operational shaft 9. This speed-changing operational arm 10 is operatively coupled with a speed change pedal 12 disposed on a right side of a driver's step 11 via a coupling link 13.

The speed change pedal 12 is supported to be pivotable about a support shaft 14. When a forward traveling operational portion 12f provided forwardly of the pivot shaft 14 is stepped on, the speed-changing operational shaft 9 is pivotally operated in a forward accelerating direction. Whereas, when a reverse traveling operational portion 12r provided rearwardly of the pivot shaft 14 is stepped on, the speed-changing operational shaft 9 is pivotally operated in a reverse accelerating direction.

At the base end of the speed-changing arm 10, there is provided a neutral returning mechanism 15, which is constructed such that when the step-on operation of the speed change pedal 12 is released, the speed-changing operational shaft 9 may be automatically returned to its neutral position of a zero swash plate angle. More particularly, this neutral returning mechanism 15 consists essentially of a V-shaped cam groove 16 formed in the base portion of the speed-changing operational arm 10 and a push lever 19 supported to be pivotable about a pivot shaft 17 and pivotally urged by a spring 18. At an end of the push lever 19, there is attached a roller 20 which is pressed against the cam groove 16. When the roller 20 is received within the center recess of the cam groove 16, the speed-changing operational shaft 9 is maintained at it neutral position. From this neutral position, if the speed change pedal 12 is stepped on forwardly or rearwardly to pivot the speed-changing operational arm 10 in the forward rotation (forward traveling) or reverse rotation (reverse traveling) direction, the resultant pivotal displacement of the cam groove 16 causes the roller 20 to be retracted against the push urging force. When the step-on operation of the speed change pedal 12 is released, the speed-changing operational shaft 9 is automatically returned to its neutral position, by the neutral returning force due to the internal oil pressure of this speed-changing operational shaft 9 with the aid of a cam function due to the pressing of the roller 20 against the cam groove 16.

From an arm portion 12a of the speed change pedal 12, a rod 21 is pivotally extended rearward, and an end metal element 22 provided at a rear end of this rod 21 is supported via a fore-and-aft slot 25 to a guide pin 24 attached via a bracket 23 to a lateral face of the transmission case 8. In operative association with the forward or rearward step-on operation of the speed change pedal 12, the end metal element 22 is moved linearly back and forth.

The end metal element 22 is disposed so as to be moved back and forth, downwardly of the right side of the driver's seat 3. Upwardly adjacent this end metal element 22, there is mounted a speed-maintaining lever 27 which is pivotable forwardly and rearwardly about a support shaft 26 attached to the bracket 23.

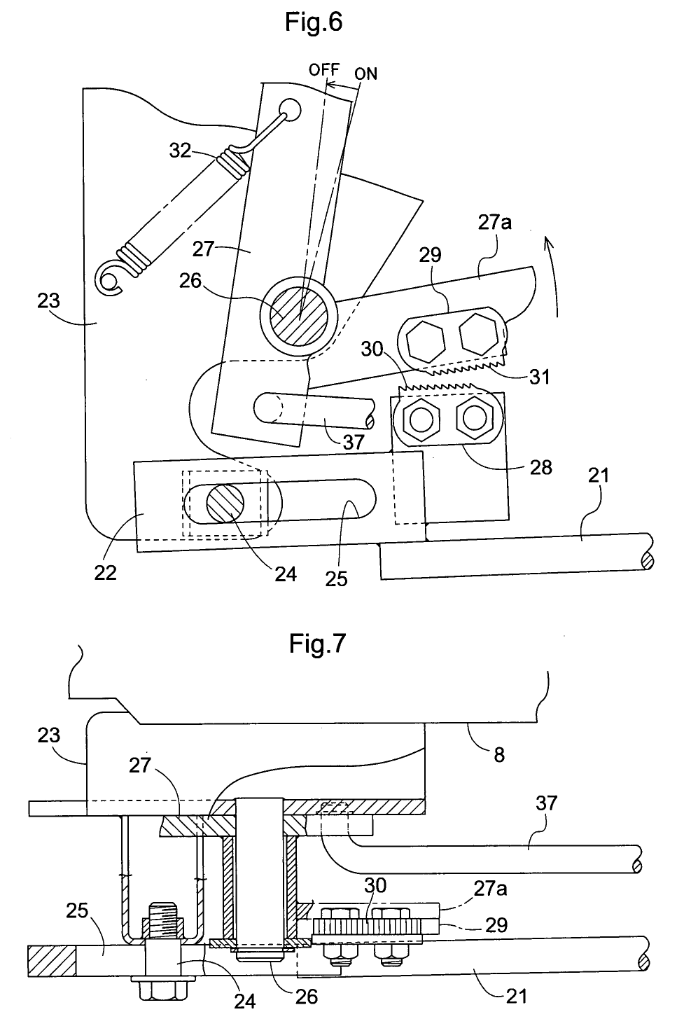

A restraining member 28 is bolt-fixed to the end metal element 22. To an arm portion 27a extending forwardly from the base portion of the speed-maintaining lever 27, there is bolt-fixed and attached a retaining member 29 which is retained to the restraining member 28. The restraining member 28 defines, in its upper side, a number of saw-tooth-like retaining pawls 30 juxtaposed along moving directions (first and second directions which are forward and rearward directions) of the restraining member 28. Each one of these engaging pawls 30, as best shown in FIG. 6, has a shape inclined progressively upward toward the rear side. The retaining member 29 defines, in its lower side, a number of retaining pawls 31 juxtaposed along the fore and aft direction, for engagement with the retaining pawls 30 of the restraining member 28. In operation, when the speed-maintaining lever 27 is pivoted rearwardly, the retaining member 29 is moved upward to be moved away from the restraining member 28. When the speed-maintaining lever 27 is pivoted forwardly, the retaining member 29 is moved downward to come into engagement with the restraining member 28.

Both the retaining pawls 30, 31 are formed like saw teeth adapted for preventing rearward movement of the restraining member 28 when the retaining member 29 comes into engagement with this retaining member 28 and inclined in a direction for allowing forward movement of the restraining member 29. The restraining member 28 and the retaining member 29 are formed by utilizing like members both punched out of a thick plate, with reversing the vertical, i.e. up/down, orientations thereof from each other.

The speed-maintaining lever 27 is pivotally urged rearward by the spring 32. Under its normal condition, the retaining member 29 is retained at a position upwardly away from the restraining member 28.

If the speed change pedal 12 is stepped on as desired in the forward/reverse direction and then the speed-maintaining lever 27 is pivoted to a forward speed maintaining position (ON) against the spring 32, the retaining member 29 will be retained and supported to the restraining member 28 which has been moved forward, in operative association with the step-on operation of the pedal. Hence, under this condition, even if the pedal step-on operation is released and the operator removes his/her hand from the speed-maintaining lever 27, as the restraining member 28 urged to return in the neutral direction is engaged and retained with the retaining member 29 urged in the engagement releasing direction by the spring 32, the engaged condition between the restraining member 28 and the retaining member 29 is maintained. Under this condition, as rearward movement of the restraining member 29 is prevented, the speed change pedal 12 is maintained under this stepped-on position, so that a constant speed forward traveling at the desired speed will take place.

During the constant speed forward traveling, rearward movement of the restraining member 28 is prevented as described above. So, it is not possible to step on the speed change pedal 12 in the decelerating direction. However, as forward movement of the restraining member 29 is allowed, if the speed change pedal 12 is further stepped in the forward traveling accelerating direction, the restraining member 28 will be moved forwardly while pushing up the retaining member 29, so that acceleration from the retained forward traveling speed is made possible.

Upon release of the engagement between the restraining member 28 and the retaining member 29 as described above, the speed-maintaining lever 27 which is pivotally urged rearward by the spring 32 will be automatically returned to a releasing position (OFF).

For realizing deceleration or reverse traveling condition from the retained desired forward traveling speed, this is possible either by operating the speed-maintaining lever 27 to the rear releasing position (OFF) to release the retaining member 29 from the restraining member 28 or by stepping on the speed change pedal 12 slightly in the forward traveling direction, thus allowing the speed-maintaining lever 27 to automatically return to the releasing position (OFF).

In the restraining member 28 and the retaining member 29, the forming lengths or length ranges of their respective engaging pawls 30, 31 are set such that these pawls may come into meshed retention or engagement with the other mating pawls only when the speed change pedal 12 is stepped on to the forward traveling speed-changing range. Thus, even if the speed change pedal 12 is stepped on to the reverse traveling speed-changing range and the speed-maintaining lever 27 is operated forwardly, there will occur no meshing engagement between the restraining member 28 and the retaining member 29. That is to say, speed maintenance is possible only during forward traveling.

And, if a braking operation is effected during a constant speed forward traveling with its speed maintenance, the speed maintenance is automatically released.

Forwardly of the speed change pedal 12, there are disposed a pair of right and left brake pedals (side brake pedals) 33 for braking the right and left rear wheels 2 independently of each other. In operation, for causing the vehicle body to make a small radius turn, the front wheels 1 will be steered greatly and at the same time one brake pedal 33 which is located, relative to the other pedal, on the inner side of the turn to make will be stepped on to brake one rear wheel 2 which is on located, relative to the other rear wheel, on the inner side of the turn. On the other hand, for decelerating or stopping the traveling vehicle body, the right and left brake pedals 33 will be stepped on simultaneously, so as to brake the right and left rear wheels 2 at a time.

More particularly, the right and left brake pedals 33 are operatively coupled to a double-stepping detecting link mechanism 34. This double-stepping detecting link mechanism 34 is constructed such that an operational link 36 pivotable about a pivot axis 35 will not be pivoted when only one of the right and left brake pedals 33 is stepped, whereas the operational link 36 will be pivoted largely forwardly only when both of the right and left brake pedals 33 are stepped on simultaneously. An operational rod 37 pivotally extending rearward from the operational link 36 is connected to a lower extending end of the speed-maintaining lever 27.

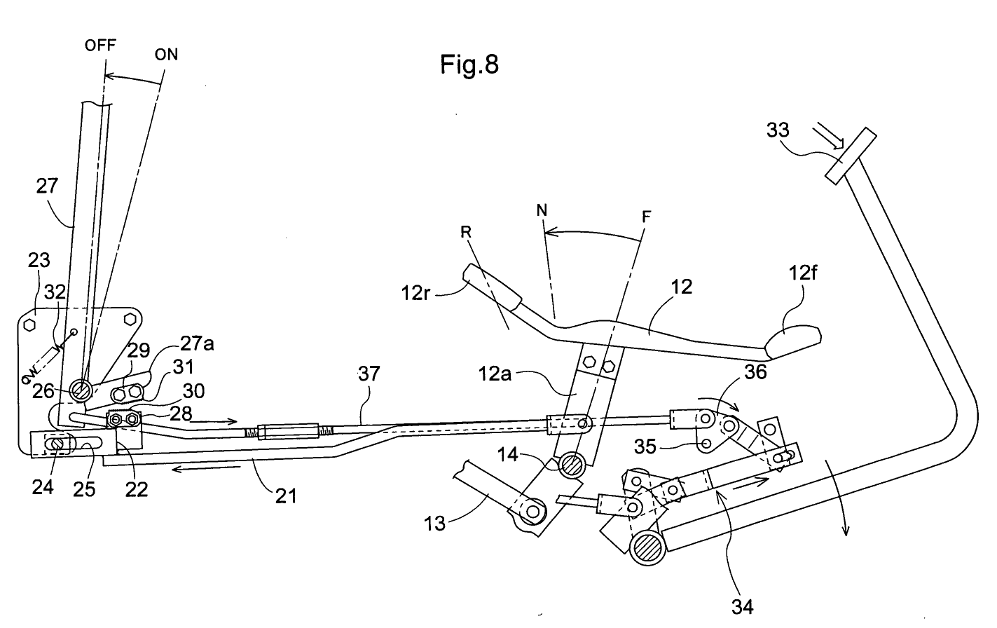

With the above-described construction in operation, as illustrated in FIG. 8, if both the brake pedals 33 are stepped on at a time during traveling at a desired forward traveling speed maintained as a result of an operation of the speed-maintaining lever 27 to the forward speed maintaining position (ON), the operational link 36 will be pivoted forwardly as described above, so that the operational rod 37 will be pulled forward, thus forcibly moving the speed-maintaining lever 27 to the rear releasing position (OFF). Consequently, the speed maintenance will be released and the HST 7 will be allowed to return to its neutral position.

### Other Embodiments

(1) In the foregoing embodiment, the restraining member 28 is moved linearly back and forth, in association with a step-on operation of the speed change pedal 12. Alternatively, the speed-maintaining means can be constructed as a rotary ratchet type retaining construction. Namely, the restraining member 28 may be supported to be pivotable about a horizontally oriented pivot axis, and in association with a step-on operation of the speed change pedal 12, the retaining member 29 comes into engagement with a number of retaining pawls formed along the outer periphery of the restraining member 28.

(2) The speed-maintaining lever 27 can be constructed as a push/pull lever vertically linearly operable and urged upward in its pulling direction, so that in association with an upward pulling operation of this speed-maintaining lever 27, the retaining member 29 included in this lever27 will be disengaged from the restraining member 28; whereas, in association with a push-down operation of the speed-maintaining lever 27 against the upward urging force, the retaining member 29 will be engaged and retained to the restraining member 28, for maintaining a speed.

What is claimed is:

1. A speed change operating structure for a hydrostatic continuously variable speed-change apparatus of a work vehicle, the operating structure comprising:
a speed change pedal for effecting a speed-changing operation of the hydrostatic continuously variable speed-change apparatus, the speed change pedal being urged in a direction toward its neutral position;
a speed-maintaining lever disposed adjacent a lateral side of a driver's seat included in the work vehicle;
a retaining member displaceable by an operation of the speed-maintaining lever in an operational direction and in an opposite direction to the operational direction; and
a restraining member movable in a first direction and a second direction opposite to the first direction, in association with an operation of the speed change pedal, the restraining member being engageable with the retaining member at a plurality of positions, an engagement between the restraining member and the retaining member preventing movement of the speed change pedal in the direction toward the neutral position thereof.

2. The speed change operating structure according to claim 1, wherein the engagement of said restraining member with said retaining member is releasable by movement of said restraining member in one of said first and second directions.

3. The speed change operating structure according to claim 2, wherein said restraining member is configured to allow movement of the restraining member in association with an operation of the speed-changing lever in an accelerating direction, when engaged with said retaining member.

4. The speed change operating structure according to claim 2, wherein said restraining member is configured to inhibit movement of the restraining member in association with an operation of the speed-changing lever in a decelerating direction, when engaged with said retaining member.

5. The speed change operating structure according to claim 2, wherein said retaining member is disposed on a lateral side of the work vehicle where said speed change pedal is present and downwardly of a lateral side of the driver's seat in the fore and aft direction of the work vehicle;
said speed-maintaining lever is supported to be movable-in the fore and aft direction of the vehicle body at a position on the lateral side of the driver's seat; and
a link coupled with said restraining member for transmitting an operational force from said speed change pedal to said restraining member extends along a transmission case of the work vehicle.

6. The speed change operating structure according to claim 2, wherein a brake laver is operatively coupled with said speed-maintaining lever so as to forcibly move said speed-maintaining lever from a speed maintaining position to a releasing position, in association with a step-on operation on the brake pedal.

7. The speed change operating structure according to claim 1, wherein said first and second directions are directions along the fore and aft direction of the work vehicle.

8. The speed change operating structure according to claim 1, wherein said restraining member includes a number of retaining pawls provided along said first direction and said retaining member includes a number of retaining pawls engageable with said retaining pawls of the restraining member.

9. The speed change operating structure according to claim 8, wherein said restraining member and said retaining member are comprised of members of a same shape having said respective retaining pawls along one side thereof.

10. The speed change operating structure according to claim 3, wherein said speed-maintaining lever is urged in a direction for releasing engagement between said retaining member and said restraining member, and the engagement between said restraining member and said retaining member is maintained through mutual retention between said restraining member urged in the neutral direction and said retaining member urged in an engagement releasing direction.
